(19) United States
(12) Patent Application Publication
(10) Pub. No.: US 2009/0256387 A1
(43) Pub. Date: Oct. 15, 2009

(54) Motor vehicle with a roof arrangement

(75) Inventors: Kurt Pfertner, Friolzheim (DE); Wolfgang Dittrich, Bietigheim-Bissingen (DE)

Correspondence Address: RATNERPRESTIA, P.O. BOX 980, VALLEY FORGE, PA, 19482, US

(73) Assignee: Dr. Ing. h.C.F. Porsche, Weissach (DE)

(21) Appl. No.: 12/384,800

(22) Filed: Apr. 9, 2009

(30) Foreign Application Priority Data
Apr. 12, 2008 (DE) 10 2008 018 577.9

(51) Int. Cl. B60J 7/04

(52) U.S. Cl. 296/180.3

(57) ABSTRACT

A motor vehicle with a roof arrangement and a spoiler means lying behind the roof arrangement, whereby the roof arrangement has at least one movable roof element, which is adjustable between a closed position and an open position.

The roof element is designed as automatically adjustable in the direction of the closed position starting from its open position for achieving a defined, presettable aerodynamic effect at the spoiler means.

### CROSS REFERENCE TO RELATED APPLICATIONS

This application claims priority to DE 10 2008 018 577.9 filed Apr. 12, 2008, the contents of such application being incorporated by reference herein in its entirety.

### FIELD OF THE INVENTION

This invention relates to a motor vehicle having a roof arrangement.

### BACKGROUND OF THE INVENTION

A motor vehicle has become known from the class-forming DE 101 38 027 A1. It has a roof arrangement, which has at least one movable roof element, such that a roof opening of the motor vehicle can be released at least partly, when the roof element is adjusted into an open position. The roof opening is closed when the roof element occupies a closed position. An aerodynamic spoiler means is embodied behind the roof arrangement in the form of a so-called roof spoiler. In order to achieve various aerodynamic effects, the roof spoiler can be shifted, opened up more or less wide and assume various setting angles depending on the driving speed and/or the position of the roof.

### SUMMARY OF THE INVENTION

An object of the present invention is to provide a motor vehicle of the type mentioned in the introduction, in which the comfort and performance of the motor vehicle are optimized.

The advantages mainly achieved with the present invention can be seen in that due to the automatic movement of the roof element in the closing direction, the air flow guided over the roof arrangement during the travel of the vehicle can flow largely undisturbed up to the spoiler means, as a result of which this spoiler means, in an especially preferred embodiment, can exhibit an especially favorable aerodynamic effect. In an especially preferred embodiment, this defined, presettable effect will be a maximum achievable output force, such that a corresponding pressure on the roadway may take place especially in the area of the rear axle of the motor vehicle, which may be especially the driven axle.

According to an especially preferred exemplary embodiment not only is the roof element of the roof arrangement adjustable, but also the spoiler means, which, according to this, can be moved between a withdrawn inoperative position and an aerodynamically effective extended position. Provisions may especially be made for this that the spoiler means is moved between the inoperative position and the extended position depending on the driving speed. It is advantageous when the spoiler means is able to occupy various extended positions of varying aerodynamic effect. Preferably, this takes place continuously, such that an optimal adaptation of the spoiler means to desired driving properties of the motor vehicle is possible.

According to another preferred exemplary embodiment, the spoiler means can be moved between the withdrawn inoperative position and the aerodynamically effective extended position depending on the position of the sliding roof. Thus, in some adjustment ranges, the effect of the open sliding roof can be compensated by adjusting the spoiler means, so that an as optimal as possible aerodynamic effect can be achieved. However, in some cases, which may be associated, e.g., even with higher driving safety, the roof element is—as described above—moved in the direction of the closed position, preferably in a fully closed position, so that the spoiler means is able to operate optimally.

Especially preferably, a roof arrangement of this type will contain a sliding roof, which is designed as slidable over a roof membrane, which can be designed, for example, as fixed, for the open position. In other words: In a preferred embodiment, the roof arrangement is a so-called outside-guided or outside-running sliding roof.

The present invention is explained in detail below based on an exemplary embodiment with reference to the drawing.

### BRIEF DESCRIPTION OF THE DRAWINGS

FIGS. 1 through 3 show partial lateral views of a motor vehicle, in which a roof arrangement and a spoiler means can occupy different positions.

### DETAILED DESCRIPTION OF THE DRAWINGS

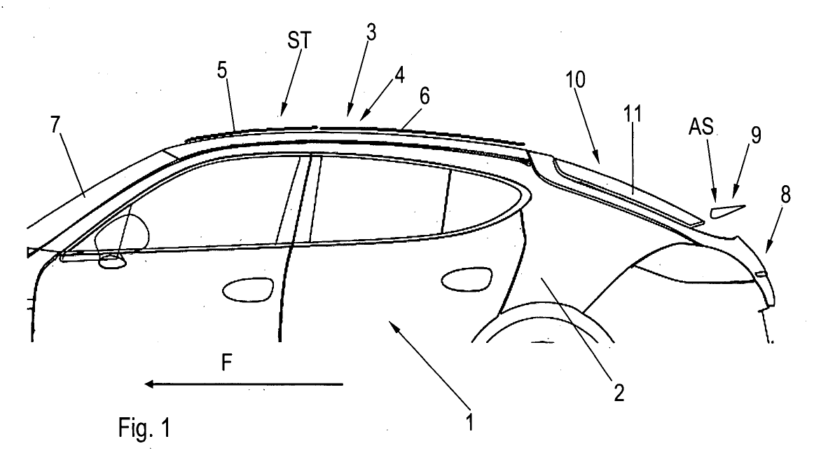

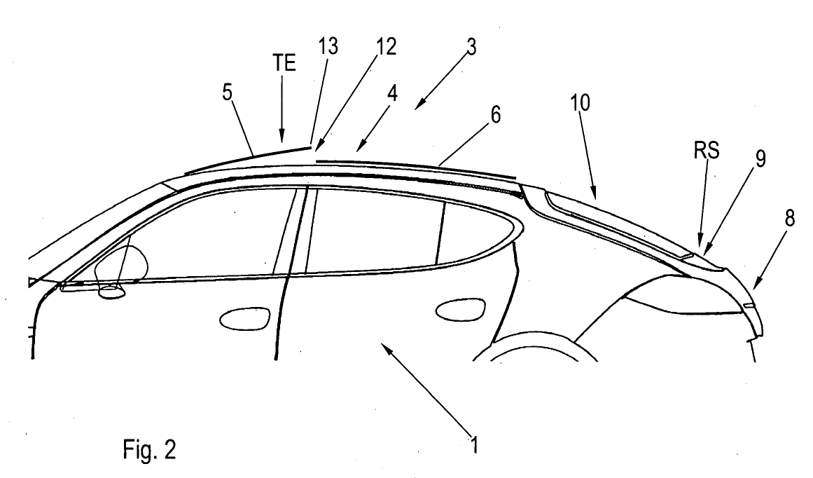

In FIG. 1 can be seen a motor vehicle 1, which has a body 2, which, besides other body parts not described in detail, also has a vehicle roof 3. Into the vehicle roof 3 is inserted a roof arrangement 4, which has at least one linear movable roof element 5 and a preferably fixed, i.e., unmovable, roof membrane 6 arranged behind it. Thus, the following arrangement is produced: The roof element 5, to which the roof membrane 6 is connected, is inserted after a windshield 7. This applies in relation to a vehicle front not shown here and a vehicle rear 8 of the body 2. Between the vehicle rear 8 and the roof arrangement 4 is arranged a spoiler means 9, which is adjusted into an aerodynamically effective extended position AS in FIG. 1. A withdrawn inoperative position RS of the spoiler means 9 can be seen in FIG. 2. For example, the spoiler means 9 is arranged on a rear cover 10 of the body 2, which carriers a rear window 11 between the spoiler means 9 and the roof arrangement 4. It can be seen that a body line inclined from the roof arrangement 4 in the direction of the rear 8 is present, in which the spoiler means 9 lies beneath the level of the roof arrangement. Otherwise, the spoiler means 9 lies—in relation to the vehicle front—behind the roof arrangement 4 and forms a rear-side spoiler means 9.

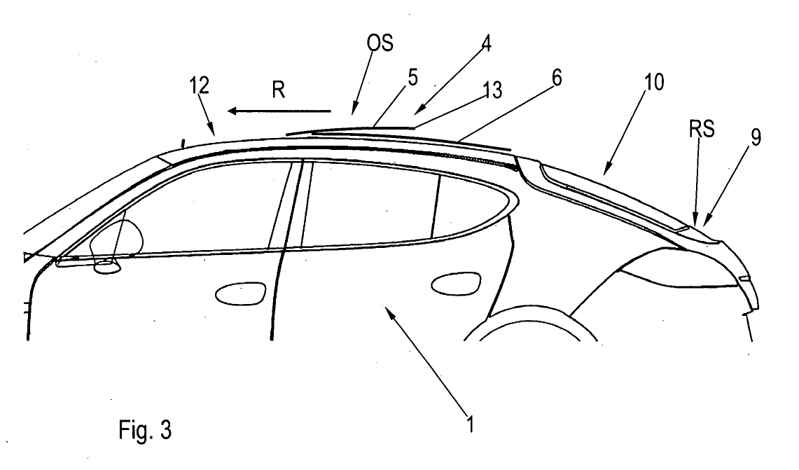

The at least one roof element 5 of the roof arrangement is shown in FIG. 1 in a closed position ST, in which a roof opening 12 (FIGS. 2 and 3) is completely closed. By aligning at least its rear edge 13, the roof element 5 can be shifted over the roof membrane 6 by subsequent linear displacement, so that the roof element 5—starting from its partly open position TE shown in FIG. 2 with raised rear edge 13 can be moved into an open position OS, which can be seen in FIG. 3 and in which the roof opening 12 is at least partly released. The roof element 5 can occupy any partly open position between the closed position ST and the open position OS.

Especially in that the roof element 5 comes to lie in the open position OS above the roof membrane 6 and/or above the rear cover 10, an air flow guided over the vehicle roof 3 during the travel (arrow F) of the vehicle 1 is influenced, such that the air flow does not optimally flow against the spoiler means 9 located in the extended position AS under the circumstances. To prevent this, according to aspects of the present invention, the roof element 5 of the roof arrangement 4, which is especially designed as a sliding roof, can move, especially in a special driving situation, from its open position OS in the direction R of the closed position ST, when the spoiler means 9 shall exhibit a defined, presettable aerodynamic effect. Preferably, provisions are made that the roof element 5 is brought into the fully closed position ST in which the roof opening 12 is closed. Driving situations of this type may occur, for example, when the motor vehicle 1 is driven in the so-called limit range. This may be achieved intentionally or unintentionally by the driver of the motor vehicle. It would be conceivable as well, however, especially in a desirable, sporty adjustment of the motor vehicle, which includes, for example, changes in the adjustable chassis, motor parameters or the like, for the roof element 5 to be moved automatically in the direction R of the closed position ST, when this defined sportiness is activated. Activations of this type have become known as so-called sport mode, in which different vehicle properties can be adjusted in the direction of sporty or comfortable.

Preferably, the roof element 5 is moved in the direction of the closed position ST when the spoiler means 9 shall deliver a maximum achievable aerodynamic effect, such as, for example, a maximum producible output force. For this, it is necessary for the above-mentioned air flow to be able to flow essentially as unaffected as possible up to the spoiler means 9 in the extended position AS. It would also be conceivable, however, for the spoiler means to be designed as fixed, such that it occupies the extended position AS constantly. Nevertheless, in certain driving situations, the roof element 5 can be moved in the direction R of the closed position ST in order to be able to achieve an optimal aerodynamic effectiveness with a fixed spoiler means.

For the closing of the roof element 5 according to the present invention, it would additionally be conceivable for the spoiler means 9 to be adjusted in different extended positions AS between the withdrawn inoperative position RS and the maximum extended position AS shown depending on the position of the roof element 5 in order for the spoiler means 9 to exhibit an optimized aerodynamic effect in case of an open roof arrangement 4.

While preferred embodiments of the invention have been described herein, it will be understood that such embodiments are provided by way of example only. Numerous variations, changes and substitutions will occur to those skilled in the art without departing from the spirit of the invention. It is intended that the appended claims cover all such variations as fall within the spirit and scope of the invention.

1.-6. (canceled)

7. Motor vehicle with a roof arrangement and a spoiler means positioned at a location behind the roof arrangement, whereby the roof arrangement has at least one movable roof element that is adjustable between a closed position and an open position, wherein the roof element is automatically adjustable in a direction toward the closed position starting from an open position for achieving a defined, presettable aerodynamic effect at the spoiler means.

8. Motor vehicle in accordance with claim 7, wherein the presettable aerodynamic effect is a maximum achievable output force.

9. Motor vehicle in accordance with claim 7, wherein the spoiler means is adjustable between a withdrawn inoperative position and an aerodynamically effective extended position.

10. Motor vehicle in accordance with claim 7, wherein the spoiler means is adjustable to various extended positions depending on the position of the roof element.

11. Motor vehicle in accordance with claim 7, wherein the spoiler means is continuously adjustable depending on the position of the roof element.

12. Motor vehicle in accordance with claim 7, wherein the roof arrangement has a sliding roof, which is slidable over a fixed roof membrane to the open position.

13. Motor vehicle in accordance with claim 7, wherein the roof element is automatically adjustable in the closed position.
